(19) United States
(12) Patent Application Publication
(10) Pub. No.: US 2004/0067735 A1
(43) Pub. Date: Apr. 8, 2004

(54) Selection of an appropriate network resource node in a cellular telecommunication system

(76) Inventor: Nigel C. Lobley, Ipswich (GB)

Correspondence Address: Nixon & Vanderhye, 8th Floor, 1100 North Glebe Road, Arlington, VA, 22201-4714, US

(21) Appl. No.: 10/468,281

(22) PCT Filed: Mar. 11, 2002
(86) PCT No.: PCT/GB02/01090

(30) Foreign Application Priority Data
Mar. 16, 2001 (EP) 01302459.1

(51) Int. Cl. H04B 7/00

(52) U.S. Cl. 455/41.2; 455/515

(57) ABSTRACT

When a mobile device 11 is switched on it registers with a base station 13. A network node 25 for connection to the mobile device 11 is then selected. The selected node 25 will remain connected to the mobile device for as long as it remains switched on, despite changes in base station 3, 13, 23. In selecting the appropriate node 25 a capability and service set required by the individual user terminal 11 is taken into account. In order to achieve this, data stored in the HLR 2 of the user's home network is retrieved, the HLR being identified by the identity code (known as an IMSI) of the user device 11.

The HLR 2 identifies the most suitable MSC 25, based on a service profile of the user, and information on the capabilities of the MSCs, held on the HLR 2. The HLR 2 then returns a signal identifying one or more suitable MSCs 25. If there is no single preferred MSC, selection may be based on other criteria such as loadings, network constraints, etc.

The selection process may be carried out by the radio base station 13, or by a network node 15 to which initial connection is made by the base station 13, control being transferred to a more appropriate node 25 if such a node is identified.

This invention relates to mobile cellular telecommunication systems.

In a cellular telecommunication system, mobile user terminals communicate with a network switching node through a radio connection to a radio base station connected to the network switching node. Each such switching node typically serves several hundred radio base stations, collectively covering a large area. (For example, the “Cellnet” network in the United Kingdom has about thirty switching nodes, serving several thousand radio base stations). The radio base stations come under the control of a control system, known as the BSC (base site controller) in the GSM standard, or the RNC (radio network controller) in the new UMTS standard. Generally each BSC controls several base stations.

In circuit-switched systems such as the GSM system the switching node is known as the MSC (mobile switching centre). In packet switching systems such as GPRS (General Packet-switched Radio System) the switching (routing) node is known as a SGSN (serving GPRS support node). The UMTS standard uses similar terminology.

The user terminal is supported by a switching centre associated with the base station and BSC with which it is radio communication. Although each switching centre is assocaited with several hundred base stations, usually grouped by area, from time to time individual mobile user terminals pass from the control of one switching node (MSC or SGSN) to that of another. They may move between two switching nodes both forming part of their home network, or they may move to, from, or between switches not forming part of their home network. In the latter case, known as “roaming” between networks, inter-network signalling costs are incurred when the user is not connected to the home network. Associated with the switching node is a store (known in the GSM standard as a VLR: visitor location register) which stores the details of the mobile user terminals currently controlled by the respective switching node.

Every time a mobile user terminal moves into an area served by a different switching node, subscriber data must be downloaded to the switching node which is now to serve the user, from a permanent store in the user's home network, (known as the HLR: home location register), and is deleted in the register associated with the switching node from which it has moved. If users frequently move between coverage areas (which will happen if users' travel patterns cover an area large in proportion to the coverage areas of the individual switching nodes) this transfer of subscriber data will represent a large signalling load.

Recent proposals use a “Core Network Selection Node” within the radio network to provide an architecture that is scalable to compensate for varying loading levels and able to service any subscriber distribution. To achieve this, a region of coverage is shared between the available core network resources, such that individual elements of the radio access network can be accessed through more than one switching centre. When a mobile user terminal is switched on within the area of coverage of such a system, or enters its area of coverage, it is allocated to one of the switching centres in the system, according to criteria such as the current load on the individual switches. The relative geographical locations of the mobile user terminal and the switches may be used to select the switching node to which the mobile user terminal is allocated. However, unlike existing systems, if the user terminal subsequently moves to a part of the coverage area remote from the switching node it continues to be served by the original switching node. Whilst the user terminal remains switched on and within the area of coverage of the system, it will remain connected to the same switching node, however many different radio base stations it is served by during that time. This concept removes the requirement to have only one switching node associated with each part of the radio access network. It allows load sharing between switching nodes, so that heavy call traffic in one part of the area of coverage can be shared between several switching nodes. It also reduces the volume of minimisation of transfers between switching nodes or other serving subsystems, thus the signalling overhead associated with mobility management is reduced. This reduction in signalling is equally applicable to subscribers moving within their home network and to subscribers “roaming” between co-operating networks. In particular, signalling between the visited and home networks is reduced as the HLR of the home network receives fewer “location updates” (which actually report the identity of the serving MSC).

If the mobile user terminal leaves the area of coverage, or is switched off, and then subsequently re-registers in the same area, the allocation process is repeated. The mobile user terminal may be allocated to a different switching node on this subsequent allocation, depending on current loadings and locations, or the same switch node may be used if the mobile passes the appropriate identifying information to the Core Network selection node. A system of this general type is disclosed in International Patent Specification WO99/08392 (Northern Telecom)

The present invention relates to a further use of this proposed network architecture. In existing systems, if a service is to be offered to users throughout a given area of coverage, all switches in the network must have the capability to support that service. The introduction of new services, or modification of existing ones, therefore requires a large capital outlay to upgrade all switches in the network with the revised services before any mobile user terminal can use the service in question throughout the whole network.

According to one aspect of the invention there is provided a mobile radio telecommunications network comprising a plurality of radio network resources for establishing radio contact with mobile devices, a plurality of network resource nodes for controlling the operation of connections involving said mobile devices, wherein the network is arranged such that a radio network resource may be connected to any of the resource nodes for the purpose of controlling the operation of a given mobile device,

wherein there is provided means for selecting the appropriate network resource node for control of a given mobile device in contact with one of the radio network resources, the selection being made according to the identity of the mobile device.

According to another aspect there is provided a method of controlling access to a mobile radio telecommunications network comprising a plurality of radio network resources for establishing radio contact with mobile devices and a plurality of network resource nodes for controlling the operation of connections involving said mobile devices, the network being arranged such that a radio network resource may be connected to any of the resource nodes for the purpose of controlling the operation of a given mobile device, the method comprising the step of:

selecting the appropriate network resource node for control of a given mobile device in contact with one of the radio network resources, the selection being made according to the identity of the mobile device.

This differs, both from conventional systems and the prior art system referred to above, in that neither prior art system takes account of the identity of the mobile unit when allocating a switch. The cited Northern Telecom system differs from the conventional system in that takes less account of location in order to satisfy load balancing requirements, and is made capable of allocating any mobile unit to any switch. In the present invention, the identity of the mobile device itself is an additional factor used in the selection of individual mobile devices todividual users be allocated to specified switching nodes in the network. They may then remain associated with that node as they move about the system.

Within existing mobile networks, all the switching nodes within a service provider's network serving a distinct geographical area generally have to support the service provider's services. This is to ensure that users can access the whole range of user services across the whole geographical area. This invention allows the delivery of services specific to certain groups of users without the need to provide the capability to support those services on all switching nodes in the network. The invention allows specified users to be grouped or ‘steered’ towards certain switching nodes within the network, allowing service providers to provide services to restricted groups of users using these selected switching nodes without having to load the service delivery mechanisms onto all switching nodes in the mobile network. New network resources or capabilities can therefore be introduced piecemeal, on one switching node at a time, without limiting the new capacity to a particular geographical area. The number of nodes capable of supporting the new capabilities can then be increased subsequently if demand for the service requires it.

The invention also allows the sharing of a radio access network by several network service providers, by allowing switching nodes of different service providers, each supporting mobile devices of their own subscribers, to connect to the same radio base stations. This allows more efficient use of resources, in particular avoiding the need for duplication of capacity to serve different service providers in the same area. Using the invention, new service providers can readily provide coverage for their subscribers over a wide geographical area without major initial outlay in switch infrastructure. This is useful for new network service providers wishing to minimise their initial deployment costs while maximising coverage. A network selection node can be configured to enable users who subscribe to different network service providers to be directed to the relevant switching nodes operated by their respective network service providers.

At present “mobile virtual network” service providers operate by re-selling service or airtime of other mobile network service providers to their customers. The present invention allows the provider of a radio network to allow connection of a “virtual” service providers' own network switching nodes to the existing radio network. The network selection node determines through which switching node (and therefore which service provider) signalling interactions should be sent on an individual user basis.

The Core Network Node Selection function can therefore be used to select the most suitable switch node on the basis of the information passed from the user terminal. This information enables unique identification of the service provider operating the core network nodes to be used by the user terminal. Thus the invention can be applied to enable sharing of the radio access network between different core network service providing operators.

Control may be effected by the radio network resources or by one of the network resource nodes. In the latter case, the node would establish initial contact with a mobile device. In either case data relating to the mobile device would be accessed, either from a local store or from the Home Location Register of the user's home network. This would allow selection of the appropriate network resource node. Control of the mobile user device could then be passed to the selected node

The appropriate network resource node may be identified by reference to a network service capability set required by the mobile device and identifying network resource nodes having the said capability set. Other information obtainable from the user identity, such as the service provider it is associated with, may also be used.

In a preferred arrangement, a network using this invention has a core network selection node placed within the radio access network, whose purpose is to assign specific core network resources, including an assigned switching node, to serve a mobile device. Subsequently all network-interface messages for that mobile device are routed to the assigned switching node.

Embodiments of the invention will now be described, by way of example, with reference to the drawings in which:

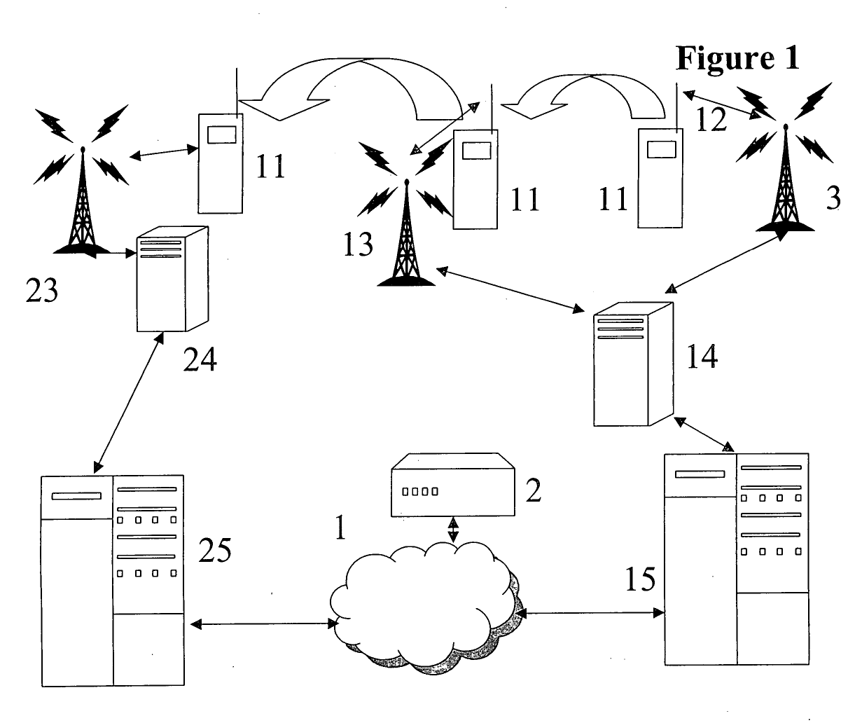

FIG. 1 illustrates schematically the architecture of a typical cellular communications system

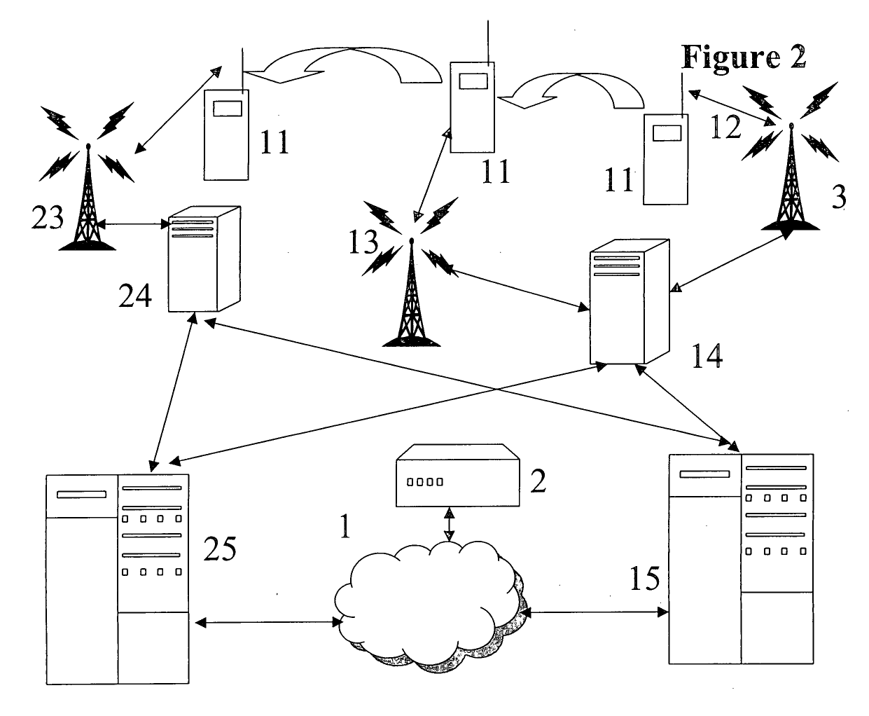

FIG. 2 illustrates schematically the proposed “Core Network Selection Node” system used by the present embodiment

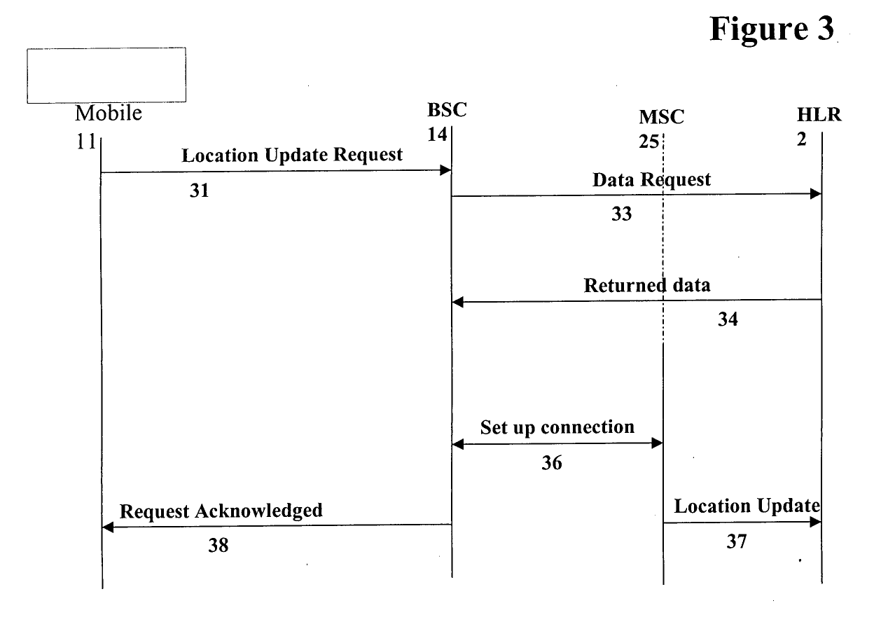

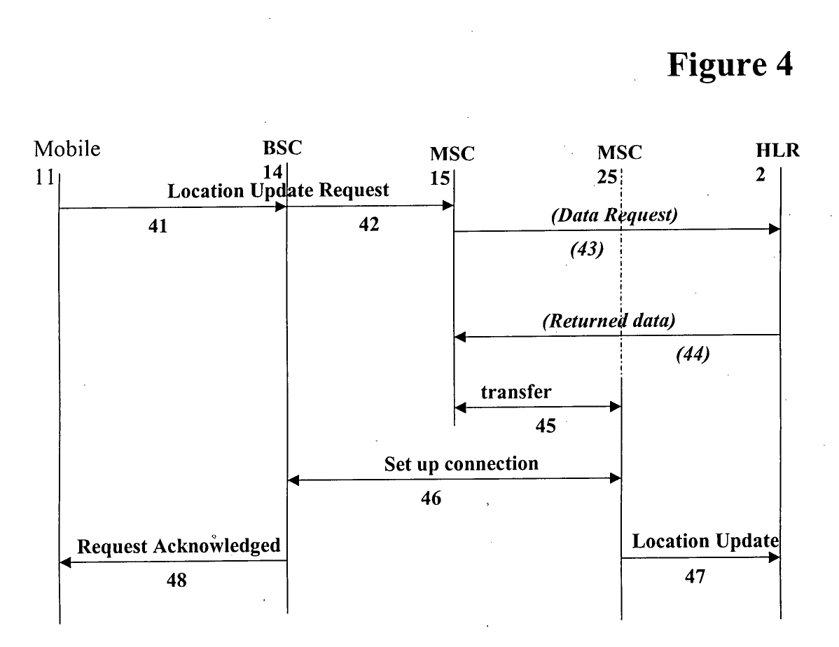

FIGS. 3 and 4 illustrate two possible implementations of the invention.

FIG. 1 shows in schematic form part of a conventional cellular communications system. A mobile user terminal 11 communicates with other subscriber terminals (fixed or mobile) through a radio communications link 12 to a radio base station 3 which is under the control of a base site controller 14, and communicates through it to a switching node 15, and thence to other switching nodes of the same or other networks through interconnections 1. In a circuit switched system the node 15 is known as an MSC (mobile switching centre) and in the GPRS packet system it is known as a SGSN (serving GPRS support node). As the mobile user terminal 11 moves around the area covered by the system it may replace contact with the radio base station 3 re-re- by contact with another base station 13 in a controlled process known as “location update”. This process ensures that calls can still be routed to the user terminal. If the first and second radio base stations 3, 13 are served by the same switching node 15 (although not necessarily by the same base site controller 14, as shown), the location update can be controlled by the switching node 15. However, transfer may be to a radio base station 23 (and associated base site controller 24), served by a different switching node 25, belonging to the same or a different service provider. In this case control must be passed to the second switching node 25. Moreover, in order that incoming calls can be routed to the user terminal 11 by way of the correct switching node 15, 25, a register 2 (known as the Home Location Register) is maintained by the user's own service provider (which may also operate one or more of the switching nodes 15, 25) which records the identity of the switching node 15, 25 to which calls to the user terminal should be routed. The home location register 2 also stores data relating to the user, which can be accessed by the switching nodes 15, 25 when they assume control of the user terminal 11.

If a call is in progress at the time of a location update, a “handover” process, arranged to allow continuity of the call despite the change in radio path, is also carried out. de information) is made within the register 2 (known as the Home Location Register). If the radio base station 23 (and associated base site controller 24), is served by a different switching node 25, belonging to the same or a different operator the control must be passed to the second switching node 25. In order that incoming calls can be routed to the user terminal 11 by way of the correct switching node 25, a register 2 (known as the Home Location Register) which records the identity of the switching node, 25 to which calls to the user terminal should be routed is updated with the correct serving switching node 25. The home location register 2 also stores data relating to the user, which can be accessed by the switching nodes 15, 25 when they assume control of the user terminal 11.

In this conventional arrangement each base site controller 14, 24 and the radio base stations 3,13 under its control, operates in association with a dedicated switching node 15. Movement of the user terminal to the area of coverage of another radio base station 23 may require transfer of control to a different switching node 25. This requires a significant signalling overhead between the two switching nodes 15, 25 and the home location register 2. Moreover, if the switching node 25 to which transfer is to be made is busy or out of service, transfer may not be possible.

The proposed “Core Network Selection Node” system overcomes these problems by effectively pooling all the switching nodes 15,25, as shown in FIG. 2, such that control of user terminals 11 served by any of the base stations 3,13,23 can be performed by any of the switching nodes 15,25, and calls can be routed through any such node. When a user terminal first attempts communication with the network, it is allocated to the switching node 15 currently identified as most appropriate, taking into account existing loadings, current geographical location and other factors. It then remains allocated to that node 15 whatever subsequent events occur either to the user terminal or the switching node, until the terminal loses contact with the network by going out of range of the base stations 3,13,23 or by being switched off. When a user terminal next attempts communication with the network, it is again allocated to the switching node 25 currently identified as most appropriate. In general this will not be the same switching node as on the previous occasion, since traffic loadings may have changed, and the mobile user terminal may have moved since it last registered (either before or after contact was lost). Alternatively, the same node could be semi-permanently allocated to the user. Therefore, even if the user switches the terminal off and then moves, when the terminal is switched on again he may be re-re-allocated the same core network node.

In one of the embodiments to be described, a Temporary Mobile Subscriber Identity (TMSI) partitioning scheme is used to identify the currently serving switching node. The partitioning scheme allocates a sub-set of the available TMSI range to each switching node, see FIG. 3. Signalling traffic is then routed to the correct switching node based on information encoded in the TMSI. There may be separate switching nodes for circuit-switched traffic, packet switched traffic, and signalling traffic, all associated with the same TMSI.

In the present invention, in order to allocate the user terminal to a dedicated switching node, the network selection node may obtain data from an external database to determine the most appropriate switching node for the user. Alternatively, the network selection node may initially select any local or appropriate switching node, then enable the initially selected switching node to redirect the initial location update request to the dedicated switching node.

Within a network using network node selection, a routeing function is set up in the radio access network (BSC). The purpose of the routing function is to assign specific core network resources to serve a mobile device and to subsequently route all subsequent terminal-to-core network interface messages for that mobile device to the assigned switching node. (If the terminal is equipped for circuit switched and packet switched operation, there may be two such nodes, an MSC and a packet switching node).

In order to both maintain paging channel efficiency and provide full backward compatibility with existing mobile user terminals, a (P)TMSI (Temporary Mobile Subscriber Identity) partitioning scheme is used to identify the serving nodes. The TMSI partitioning scheme allocates a sub-set of the TMSI range to each MSC/VLR. The signalling traffic is then routed to the correct MSC/VLR based on information encoded in the TMSI. With node selection, each switching node can act as if it serves the whole of the coverage area. Therefore, all the switching nodes must be capable of communication with all the radio base stations within that area. Once network resources have been assigned to a mobile user terminal further update requests between the switching node 15,25 and the Home Location Register 2 are not required because the service area of each switching node is essentially the whole network. The terminal 11 does not change switching node.

The network node selection function as previously proposed assigns specific network resources to serve each mobile device to provide load-sharing among the available network resources. In determining the network resource assignment, the selection function takes into account the current loading of the network and other system considerations such as geographocal considerations that may affect the initial suitability of the assignment.

In the embodiments of the present invention shown in FIGS. 3 and 4, an additional function is provided to identify, from information encoded in the user identity of a mobile user terminal registering with the network, which of the available switching nodes it should be associated with. This may be carried out by communication with the Home Location Register to identify the number range from which the TMSI should be selected. This will cause the mobile user handset to be allocated to the appropriate switching node. In FIG. 3 this function is carried out by the radio access network, specifically by the base site controller, before a switching node is allocated. In FIG. 4 a provisional switching node is first allocated, which then carries out the suitability determination itself. This latter arrangement involves more signalling overhead, but requires no modification to the radio access network.

The base stations 3, 13, 23 play no active part in the information exchange and are therefore omitted from FIGS. 3 and 4.

FIG. 3 illustrates the message flow when a mobile device 11 registers with a base station during a change of serving base station, or when it is first switched on. The mobile device 11 has a “node selector” field set to indicate where the mobile device was previously registered. This field may be included within the current TMSI allocated to the user terminal 11. This data is transmitted (step 31 ) with other data, when the user terminal 11 first attempts communication with the base site controller 14. The base site controller 14 determines from this field whether the mobile device 11 is currently registered with an MSC with which it can establish communication. If it does not recognise the field, signifying that the currently-serving MSC is not capable of communication with the base site controller 14, the base site controller 14 must select an MSC. In the existing proposals, this is performed autonomously by the network of which the base site controller 14 forms a part, based only on network considerations such as available capacity of the MSCs 15, 25 and the connections between them and the BSC 14. In the present embodiment of the invention the capability and service set required by the individual user terminal 11 is also taken into account.

In order to achieve this, data stored in the HLR 2 of the user's home network is retrieved. (It could be stored in the user terminal 11 itself, but updating is easier if it is stored in the fixed part of the home network). The mobile device has an identity code (known as an IMSI) which identifies the user's HLR 2. The BSC 14 transmits a request 33 to the HLR 2, to retrieve user data from the HLR 2. The request also identifies the MSCs 15, 25 available for connection to the BSC 14. The HLR selects the most suitable MSC 25, based on a service profile of the user, and information on the capabilities of the MSCs, held on the HLR 2. The HLR 2 then returns a signal to the base site controller 14 (step 34) identifying one or more suitable MSCs 25. If there is no single preferred MSC, the BSC 14 may select one based on other criteria such as current loadings, network constraints, etc.

Alternatively, instead of being offered a choice of MSCs, 15,25, the user data stored on the HLR 2 may include data on the connectivity of base site controllers 14, 24 and MSCs 15, 25, so that the HLR 2 may itself select a suitable MSC 25 on the basis of the identities of the user terminal 2 and BSC 14. Although this removes the need for MSC identities to be transmitted in the request 33, it does require the HLR to be kept informed of any changes to availability of the MSCs, which can change on a more frequent scale than changes to their capabilities.

Two alternative processes will now be discussed with reference to FIG. 4. In both these processes the base site controller 14 initially allocates a provisional MSC 15 to the mobile terminal 11 (step 41). This provisional MSC 15 is selected on criteria such as current loadings, network constraints, etc. This provisional MSC 15 may hold information enabling it to determine the most appropriate MSC to handle the user terminal 11, based upon the identification (and other) information received from the user terminal 11 such as the TMSI or IMSI. (In this variant the steps 43, 44 shown in FIG. 4 are not required).

Alternatively, the provisional MSC, 15 may obtain such information by performing an exchange of information 43, 44 with the user's HLR 2, similar to that carried out between the BSC 14 and the HLR 2 in the process depicted in FIG. 3.

In either case, if the provisional MSC 15 determines that an MSC 25 other than the provisional MSC 15 should be selected, control is transferred to the selected MSC 25 (step 45). In all three embodiments, once network resources 14, 25 have been assigned to serve a particular mobile device 11, the BSC 14 sets up a communications link with the MSC 25 (step 36, 46). The standard registration updating procedures are then used between the selected MSC 25 and the HLR 2 (steps 37,47), to record on the HLR 2 the selected MSC 25 as being the currently serving MSC (step 37, 47). The serving entities 14, 25 will then handle all signalling for the associated mobile subscriber 11. The MSC 25 assigns a TMSI (from the range of TMSIs allocated to that MSC) to the mobile device 11. The mobile device 11 determines the “intra domain node selector” field according to predetermined rules (preferably setting it equal to some of the bits in the TMSI). The serving MSC 25 sends a Location Update accept message 38, 48, which includes the TMSI, to the mobile device 11. The mobile device 11 stores this identifier in a register, for subsequent use in future requests sent to the MSC 25.

If the mobile device 11 moves between base stations 13, 23 both served by the same group of MSCs 15, 25 forming the network using intra domain node selection, the serving MSC 15 does not need to perform a location updating procedure. The BSC 14, 24 reads the identifier selector field and based on its value forwards the message to the serving MSC 15. The serving MSC 15 merely updates its VLR with the identity of the new BTS 23, but needs not transmit any update information to the HLR 2. Provided the user terminal 11 remains operational with the same MSC 25, any change of base stations 3, 13, 23, whether or not served by the same base site controllers 14, 24, are transparent to the HLR 2.

1. A mobile radio telecommunications network comprising a plurality of radio network resources for establishing radio contact with mobile devices, a plurality of network resource nodes for controlling the operation of connections involving said mobile devices, wherein the network is arranged such that a radio network resource may be connected to any of the resource nodes for the purpose of controlling the operation of a given mobile device,
wherein there is provided means for selecting the appropriate network resource node for control of a given mobile device in contact with one of the radio network resources, the selection being made according to the identity of the mobile device.

2. A network according to claim 1, wherein each network resource node comprises means for establishing initial contact with a mobile device in contact with an associated radio network resource, means for accessing data relating to the mobile device, means for selecting the said appropriate network resource node, and means for transferring control of the device from the network resource node which established initial contact to the selected network resource node.

3. A network according to claim 1, wherein each radio network resource comprises means for accessing data relating to the mobile device, means for selecting the said appropriate network resource node in accordance with said data, and means for establishing control of the mobile device by the selected network resource node.

4. A network according to any preceding claim, wherein the means for identifying the appropriate network resource node comprises means for identifying a network service capability set required by the mobile device and means for identifying network resource nodes having the said capability set.

5. A network according to claim 4, wherein the network comprises means for storing data relating to the capability sets required by a plurality of mobile devices, and the means for selecting the appropriate network node comprises means for accessing said stored data on identification of the respective mobile device.

6. A network resource node of a mobile radio telecommunications network comprising means for establishing initial contact with a mobile device in contact with an associated radio network resource, means for accessing data relating to the mobile device, means for selecting an appropriate network resource node for control of the given mobile device, the selection being made according to the identity of the mobile device on the basis of the said data, and means for transferring control to the selected network resource node.

7. A radio network resource of a mobile telecommunications network, comprising means for establishing radio contact with a mobile device, means for accessing data relating to the mobile device, means for selecting, the selection being made according to the identity of the mobile device on the basis of the said data, an appropriate network resource node for control of the given mobile device, and means for establishing control of the mobile device by the selected network resource node.

8. A method of controlling access to a mobile radio telecommunications network comprising a plurality of radio network resources for establishing radio contact with mobile devices and a plurality of network resource nodes for controlling the operation of connections involving said mobile devices, the network being arranged such that a radio network resource may be connected to any of the resource nodes for the purpose of controlling the operation of a given mobile device, the method comprising the step of:
selecting the appropriate network resource node for control of a given mobile device in contact with one of the radio network resources, the selection being made according to the identity of the mobile device.

9. A method according to claim 8, comprising the steps of:
establishing initial contact between a first network resource node and a mobile device in contact with an associated radio network resource,
accessing data relating to the mobile device,
selecting the said appropriate network resource node, and
transferring control from the first network resource node to the selected network resource node if they are not the same node.

10. A method according to claim 8, comprising the steps of:
establishing initial contact between a radio network resource and a mobile device,
accessing data relating to the mobile device,
selecting the said appropriate network resource node,
and establishing control of the mobile device by the selected network resource node.

11. A method according to any of claims 8, 9, or 10, wherein stored data relating to a network service capability set required by the mobile device is accessed, and a network resource node having the said capability set is selected.
